(19) United States
(12) Patent Application Publication
(10) Pub. No.: US 2021/0179246 A1
(43) Pub. Date: Jun. 17, 2021

(54) OPTICALLY ASSISTED BALLOON LAUNCH SYSTEM

(71) Applicant: LOON LLC, Mountain View, CA (US)

(72) Inventors: Leo Chen, Sunnyvale, CA (US); James Smith, Sunnyvale, CA (US); Keegan Gartner, Los Gatos, CA (US)

(21) Appl. No.: 16/712,350

(22) Filed: Dec. 12, 2019

(51) Int. Cl. B64B 1/00; B64D 47/08; B64B 1/40; B64F 1/04

(52) U.S. Cl. CPC B64B 1/005; B64F 1/04; B64B 1/40; B64D 47/08

(57) ABSTRACT

Aspects of the technology include an automated system for launching lighter-than-air high altitude platforms (HAPs), in particular balloon-type HAPs. A launch system and process are employed that use cameras to observe balloon sway and other factors. A control system detects the angle and position of the balloon gas bubble in relation to the payload in real time in view of wind and other environmental factors. This, in turn, enables the control system to automatically actuate the release mechanism and launch the balloon system at a selected point in time. This mitigates issues that can occur with manual operator-controlled launches, and increases the likelihood of a successful HAP deployment in the stratosphere. Models created via machine learning enable the system to determine criteria indicating a likelihood of a successful launch. These models may be sued by the control system in order to select an appropriate point for launching the platform.

### BACKGROUND

Communications connectivity via the Internet, cellular data networks and other systems is available in many parts of the world. However, there are other locations where such connectivity is unavailable, unreliable or subject to outages from natural disasters and other problems. Some systems provide network access to remote locations or to locations with limited networking infrastructure via high altitude platforms operating in the stratosphere, for instance using lighter-than-air platforms such as balloons that take advantage of wind currents to stay aloft for weeks, months or longer.

Launch of balloon-type platforms involves inflating an envelope or other enclosure with lift gas. As the envelope is inflated, wind may cause the envelope to sway unpredictably. Thus, deploying balloons under less than ideal weather conditions can be very challenging. For example, launching such balloons in a windy environment can be potentially hazardous to bystanders, and in some cases, windy conditions can cause damage to the balloons or their payloads before they are fully inflated and deployed. Solutions such as using a wind shield to block wind from certain directions can become less useful when wind changes direction quickly, and the shield(s) may have to be constantly adjusted. Tower structures can be employed to protect balloons during inflation may work well until a balloon is actually launched and moves out of the exit at the top of the tower. A strong cross wind can cause the balloon to hit the tower, potentially damaging the balloon envelope or the balloon payload. Similarly, launching a balloon from a structure such as a warehouse or hangar may work well until the balloon leaves the protection of the structure and is exposed to windy conditions. Thus, it can be very difficult for the ground crew or a remote operator to determine when to launch the balloon.

### BRIEF SUMMARY

Conventional balloon launches involve manual operator input to trigger the release of the balloon and payload from the launch mechanism. This approach is highly dependent on wind conditions and the sway of the balloon. Releasing too early or too late from the launch mechanism may cause a failed launch or a collision between the payload and the launch mechanism. Timing for the trigger may often be a judgement call by the operator. In addition to swaying and other wind-related factors, launches during cold temperature operations (e.g., below freezing) may lead to errors due to slow reflexes or having to wear cumbersome gloves.

Aspects of the present disclosure are advantageous for lighter-than-air high altitude platforms (HAPs), in particular balloon-type HAPs. A launch system and process are employed that use one or more cameras (imagers) arranged at the launch facility to observe balloon sway and other factors. Imagery from the camera(s) is processed in real time by a control system to detect the angle and position of the balloon gas bubble in relation to the payload. This, in turn, enables the control system to automatically actuate the release mechanism and launch the balloon system. This mitigates issues that can occur with manual operator-controlled launches, and increases the likelihood of a successful HAP deployment in the stratosphere.

According to one aspect, a method of launching a lighter-than-air platform for operation in the stratosphere is provided, in which the lighter-than-air platform includes a balloon envelope and payload. The method comprises receiving prior to launch, by one or more processors of a control module, balloon envelope status information from at least one camera located at a launch facility; receiving, by the one or more processors, environmental information including current wind conditions from one or more environmental sensors; analyzing, by the one or more processors, the balloon envelope status information and the environmental information based on one or more launch models; selecting, by the one or more processors based on the analyzing, a launch time; and causing the lighter-than-air platform to be launched at the launch time. The balloon envelope status information may include at least one of a fill status, an envelope volume status or tilt information.

In one example, the method further comprises receiving, by the one or more processors, fill status information; and selecting the launch time is based on the fill status information. The one or more launch models may be stored in memory of the control system. In another example, the method further comprises the one or more processors adjusting one or more of a position, orientation or wind protection of a launch rig prior to selecting the launch time. Receiving the balloon envelope status information from the at least one camera can include obtaining a 3D view of the balloon envelope relative to the payload. By way of example, obtaining the 3D view of the balloon envelope may be including obtaining imagery of the envelope relative to a launch rig encompassing or otherwise partly enclosing the lighter-than-air platform.

The method may further comprise the one or more processors determining an rms or geometric center of the balloon envelope based on imagery received from the at least one camera. In another example, the method also includes receiving additional sensor information from at least one of a lidar sensor or an ultrasonic sensor. Here, analyzing the balloon envelope status information is further based on the additional sensor information. The current wind conditions may include wind vectors at one or more locations about the launch facility. The method may further comprise the at least one camera capturing post-launch imagery of the lighter-than-air platform. In this case, the method may include updating the one or more launch models based on the post-launch imagery.

According to another aspect, a control system is provided for initiating launching a lighter-than-air platform for operation in the stratosphere, in which the lighter-than-air platform includes a balloon envelope and payload. The control system comprises a sensor system including one or more camera modules and one or more environmental sensors located at a launch facility, memory storing one or more launch models, and one or more processors operatively coupled to the sensor system and the memory. The one or more processors are configured to: receive, prior to launch, balloon envelope status information from the one or more camera modules; receive environmental information including current wind conditions at the launch facility from the one or more environmental sensors; analyze the balloon envelope status information and the environmental information based on one or more launch models; select, based on the analyzing, a launch time; and cause the lighter-than-air platform to be launched at the launch time. The balloon envelope status information may include at least one of a fill status, an envelope volume status or tilt information. The one or more processors may be further configured to adjust one or more of a position, orientation or wind protection of a launch rig prior to selecting the launch time. The one or more camera modules may also be configured to obtain a 3D view of the balloon envelope relative to the payload.

And according to another aspect, a launch system for launching a lighter-than-air platform for operation in the stratosphere is provided, in which the lighter-than-air platform includes a balloon envelope and payload. The launch system comprises a launch rig and a control system. The launch rig is positioned at a launch facility, and includes a support structure surrounding an interior space configured to receive the lighter-than-air platform. The control system comprising a sensor system including one or more camera modules and one or more environmental sensors located at the launch facility, memory storing one or more launch models, and one or more processors operatively coupled to the sensor system and the memory. The one or more processors are configured to: receive, prior to launch, balloon envelope status information from the one or more camera modules; receive environmental information including current wind conditions at the launch facility from the one or more environmental sensors; analyze the balloon envelope status information and the environmental information based on one or more launch models; select, based on the analyzing, a launch time; and cause the lighter-than-air platform to be launched at the launch time.

The one or more camera modules may be configured to capture imagery of a status of the launch rig during fill of the balloon envelope with lift gas. The one or more processors may be further configured to control inflation of the balloon envelope in response to at least one of the analyzed balloon envelope status information or the environmental information. And in another example, the one or more camera modules may be configured to capture post-launch imagery of the lighter-than-air platform, and the one or more processors may be configured to update the one or more launch models based on the post-launch imagery.

### BRIEF DESCRIPTION OF THE DRAWINGS

FIG. 1 is a functional diagram of a balloon system in accordance with aspects of the disclosure.

FIG. 2A is an example of a balloon in accordance with aspects of the disclosure.

FIG. 2B is an example of a balloon payload in accordance with aspects of the disclosure.

FIG. 3 is an example perspective view of a launch support structure in accordance with aspects of the disclosure.

FIG. 4 is an example view of an interior space of the support structure in accordance with aspects of the disclosure.

FIG. 5 is an example of a portion of a portable launch rig including in accordance with aspects of the disclosure.

FIG. 6 is an example of a platform, perch, and a releasable restraint in accordance with aspects of the disclosure.

FIG. 7 is an example of a portion of a portable launch rig in accordance with aspects of the disclosure.

FIGS. 8A-B are an example cart assembly in accordance with aspects of the disclosure.

FIGS. 9A-B are example lift gas supply carts in accordance with aspects of the disclosure.

FIG. 10 is an example control system in accordance with aspects of the disclosure.

FIG. 11A illustrates a fill stage in accordance with aspects of the disclosure.

FIGS. 12A-D illustrate stages of a launch process in accordance with aspects of the disclosure.

FIG. 13 illustrates an example of a balloon upon launch in accordance with aspects of the disclosure.

FIGS. 14A-B illustrate an example of balloon sway detection in accordance with aspects of the disclosure.

FIG. 15 is an example of a system to create a balloon launch model in accordance with aspects of the disclosure

FIG. 16 is an example flow diagram in accordance with aspects of the disclosure.

### DETAILED DESCRIPTION

### Overview

The technology relates to launching lighter-than air HAPs, such as balloons configured for operation in the stratosphere. As an example, a typical balloon may include a balloon envelope having a top plate and a base plate, a plurality of tendons between the top plate and the base plate, and a payload such as to provide telecommunications (e.g., 4G, LTE, 5G, etc.) and/or other services. As noted above, it can be challenging to inflate and launch a balloon. This is especially true for large balloons (e.g., 1-5 meters in diameter, or more) in windy conditions. Various equipment can be used to aid the process. For instance, specialized clamps may hold the envelope during inflation. Wind shields and launch towers can also be used to protect the envelope and payload. In some configurations, a specialized portable launch rig (PLR) may be used. In other configurations, a fixed or rotatable launch rig may be used. The technology is not limited to any particular type of launch rig.

As an example, a PLR may include a support structure surrounding an interior space configured for inflating and launching of balloons. The support structure may include rectangular supports at opposite sides of the support structure. Each rectangular support may include side supports and top and bottom beams. A lateral support beam may connect the rectangular support structures to one another at the side supports on a back side of the support structure. In one PLR configuration, a fourth side of the support structure is framed by the two parallel side beams and is generally open in order to permit a balloon to be moved into and out of the support structure for inflating and launching.

The support structure may also include a one or more jib cranes for lifting and inflating of the balloon. In one example, the support structure may include first and second jib cranes mounted to a top surface of the lateral support beam. The jib cranes include cables that extend downward towards the interior space of the PLR. In this configuration, at the end of each jib crane cable is a connection for connecting to a beam or jib spreader. Here, each cable is controlled by a corresponding hoist which may operate to extend and retract the cables of the first and second jib crane in order to lower and raise the jib spreader. In order to keep the jib spreader parallel with respect to the ground, the hoists may operate in unison or independently using a single controller.

The jib cranes may each include a first arm portion and a second arm portion. The first arm portions may be connected to the lateral support beam and extend upwards from and generally perpendicularly to the lateral support beam. The second arm portions may be connected to the respective first arm portions and extend over the interior space. In order to increase the range of movement of the jib spreader, the jib cranes may also be moveable in multiple degrees of freedom. For instance, each of the first arms of the jib cranes may be extended or retracted towards and away from the lateral support beam using a hydraulics system. The second arms may also be pivoted and rotated relative to the first arms. In addition, as with the first arms, the second arms may also be extended and retracted.

The jib spreader may include a mount for connecting an assembly for lifting a balloon. The assembly may also be configured to provide lift gas into the balloon envelope through an opening in the top plate of the balloon. In that regard, electrical and lift gas lines may be connected to the assembly from the jib spreader.

In order to provide wind protection to the interior space, the support structure may include a three-sided door assembly. The door assembly may include retractable hangar doors each set within a corresponding rectangular hangar door frame. When fully extended, these hangar doors are configured to block the wind from the interior space from the corresponding side of the support structure, while leaving a fourth side of the PLR open. When fully retracted, the doors may be rolled up completely or almost completely inside of three respective door housings arranged adjacent to the parallel top beams and lateral support beam. These rolling doors allow the PLR's support structure to withstand higher wind conditions without imposing higher wind loads on the support structure.

In order to lift, fill and launch the balloon, a platform may be arranged within the interior space. The platform may include lateral support bars which are each connected by cables to a corresponding one of the parallel top beams of the support structure. Each cable may be controlled by a corresponding hoist which may operate to extend and retract the corresponding cable in order to lower and raise lateral support bars towards and away from the parallel top beams thereby raising and lowering the platform. The hoists may operate in unison or independently and can be used to raise and lower the platform completely independent of the cables of the jib cranes and/or in unison with the hoists of the jib cranes.

The platform may be or may include a movable perch. The perch can pivot relative to the platform in order to lift the balloon during inflation as well as to move and lift the balloon during launch. In one configuration, a first end of the perch includes a releasable restraint for holding a portion of the balloon envelope to the perch during inflation and prior to launch. A second end of the perch may be configured for attachment with the payload of the balloon. For example, the second end may include a payload positioning assembly including two or more arm having end portions which are configured to clamp onto a portion of the balloon as well as a rest structure for holding the payload prior to launch. The payload positioning assembly may position or maintain the position of the payload until the releasable restraint has been released and the balloon envelope has reached a certain height or location relative to the payload where the payload is ready to be released. This reduces the likelihood that the payload will collide with the perch, platform, or ground after the payload is released during a launch.

In another example, the second end of the perch and/or the platform may include a connection member for connecting with a cart. On end of the cart may include a rest structure for holding the balloon's payload to the perch during inflation and prior to launch. The cart is may be used to move a packaged balloon stored in a box or other housing towards the support structure. A second end of the cart may include a payload positioning assembly including two or more arms having end portions which are configured to clamp onto a portion of the balloon.

As noted above, the PLR may be used not only to launch a balloon, but also the fill the balloon. In this regard, a lift gas supply may be provided. The lift gas supply may be integrated into the support structure in order to reduce the likelihood of kinking of the lift gas supply line when the support structure is moved. Alternatively, the lift gas supply may be an independent assembly, such as a lift gas supply cart. Again, in order to reduce kinking of the lift gas supply line when the support structure is moved, the lift gas supply cart may be configured to connect and move with the support structure.

The PLR is also configured to change the position and orientation of the support structure. Each of the bottom beams may include two or more wheels each having an independent hydraulics system to turn (angle) and rotate (drive) that wheel. The independent movement of each wheel allows the PLR to have many different types of movement such as 2-wheel and 4-wheel drive modes as well as various steering modes. By changing the orientation of the wheels, the PLR can always be maneuvered such that the fourth open side of the PLR can be rotated to downwind as wind conditions at a launch site change.

The various features of the PLR may be electrically connected to a control system. Various user inputs may be included within a cab. These user inputs may allow a human operator to communication with the control system in order to control the movement and position of the wheels, platform, perch, releasable restraint, payload positioning assembly, jib cranes, hangar doors, as well as various other features of the PLR.

The PLR may also include a data acquisition system. The data acquisition system may include various sensors arranged to detect the position and location of the wheels, platform, perch, releasable restraint, payload positioning assembly, jib cranes, hangar doors, as well as various other features of the PLR.

For instance, the PLR may include a plurality of sensors configured to detect and provide information regarding current wind conditions outside of the PLR and also within the interior space. The control system may also communicate with the lift gas supply cart to control the inflation of a balloon envelope. In addition, one or more cameras are positioned on the PLR or otherwise around the launch area. The cameras are able to capture imagery of the balloon and payload, for instance to detect the tilt of the balloon relative to the payload. These sensors are configured to send information to the control system, which processes the information in real time and uses such information, including the balloon tilt, wind speed and other data, to identify when to launch the HAP.

As noted above, the PLR may be used to lift, fill and launch a balloon. In order to do so, at least a portion of the balloon may be positioned within the interior space. A box or other housing containing that balloon may be placed on the perch within the interior space. The payload may be placed on the rest structure and the end portions of the arms may be clamped onto the base plate. In addition, a roller bar or other component of the releasable restraint may be temporarily clamped onto the balloon envelope and slid towards the first end of the perch and into the interior space.

In order to lift the balloon out of the box or other enclosure, the jib spreader may then be positioned over and lowered towards the box. The assembly for lifting the balloon may then be secured to the top plate. The hoists of the jib cranes may then retract the cables in order to raise the jib spreader and pull the balloon envelope out of the box.

Prior to or once the assembly is secured to the top plate the lift gas supply cart (if used) may be wheeled over to the support structure and connected to the lift gas line. Lift gas from the supply cart may then flow into the balloon envelope via the lift gas line and assembly, until the inflating is complete or the desired inflation pressure is reached within the balloon envelope.

Once inflation is complete, the PLR is positioned for the current wind conditions, and the balloon reaches a desired orientation, the HAP may be ready for launch. At this point, the control system may cause the top plate to be released from the assembly. At the same time or shortly thereafter, the assembly may be pulled away from the top plate. In one scenario for launch, the first end of the perch is swung upwards. Next, the balloon envelope is released from the releasable restraint by swinging the roller bar away from the releasable restraint. This causes the balloon envelope to begin to rise away from the first end of the perch. At an appropriate time thereafter, such as when the balloon envelope has passed over (or beyond) the payload, the end portions of arms may be released from the base plate. The arms may swing away from the base plate, allowing the balloon (including the payload) to float away and completing the launch.

### EXAMPLE BALLOON SYSTEM

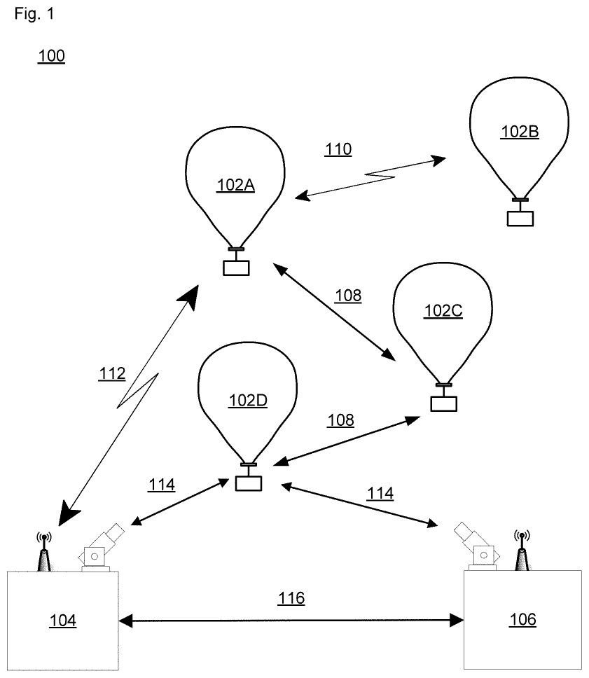

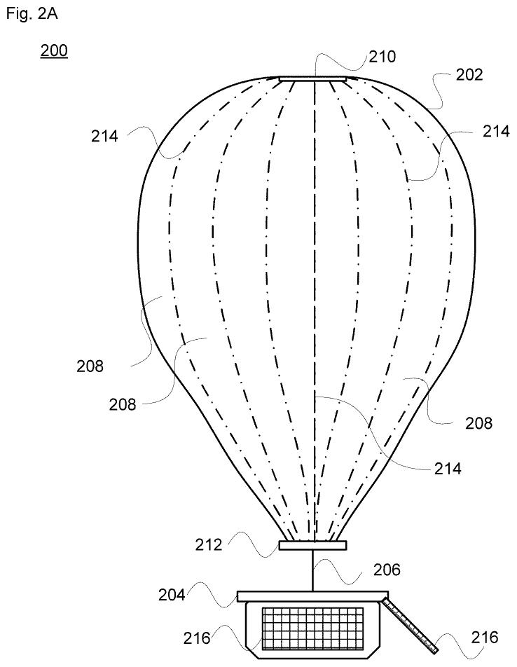

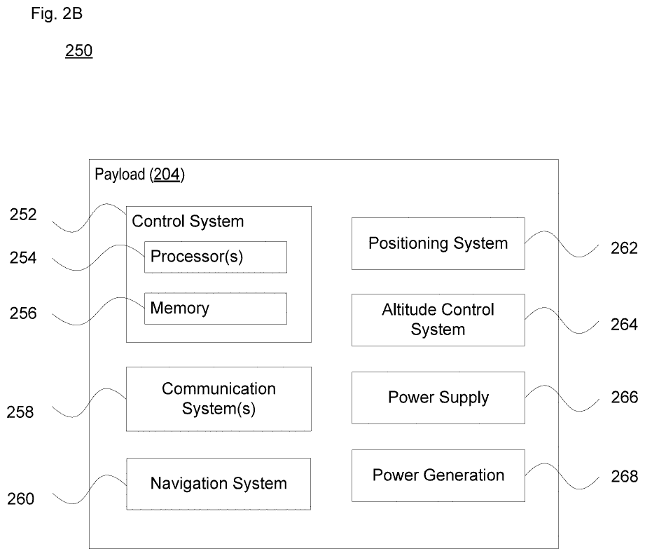

FIG. 1 depicts an example system 100 in which a fleet of balloon platforms or other lighter-than-air HAPs may be used. This example should not be considered as limiting the scope of the disclosure or usefulness of the features described herein. System 100 may be considered a balloon network. In this example, balloon network 100 includes a plurality of devices, such as balloons 102A-D as well as ground-based stations 104 and 106. Balloon network 100 may also include a plurality of additional devices, such as various computing devices (not shown) as discussed in more detail below or other systems that may participate in the network. One example of a balloon is discussed in greater detail below with reference to FIG. 2.

The devices in system 100 are configured to communicate with one another. As an example, the balloons may include communication links 108 and/or 110 in order to facilitate intra-balloon communications. By way of example, links 110 may employ radio frequency (RF) signals (e.g., millimeter wave transmissions) while links 108 employ free-space optical transmission. Alternatively, all links may be RF, optical, or a hybrid that employs both RF and optical transmission. In this way balloons 102A-D may collectively function as a mesh network for data communications. At least some of the balloons may be configured for communications with ground-based stations 104 and 106 via respective links 112 and 114, which may be RF and/or optical links. In addition, the ground-based stations 304 and 306 may communicate directly via link 116, which may be a wired or wireless link.

In one scenario, a given balloon 102 may be configured to transmit an optical signal via an optical link 308. Here, the given balloon 102 may use one or more high-power light-emitting diodes (LEDs) to transmit an optical signal. Alternatively, some or all of the balloons 102 may include laser systems for free-space optical communications over the optical links 108. Other types of free-space communication are possible. Further, in order to receive an optical signal from another balloon via an optical link 108, the balloon may include one or more optical receivers.

The balloons 102 may also utilize one or more of various RF air-interface protocols for communication with ground-based stations via respective communication links. For instance, some or all of balloons 102A-D may be configured to communicate with ground-based stations 104 and 106 via RF links 112 using various protocols described in IEEE 802.11 (including any of the IEEE 802.11 revisions), cellular protocols such as GSM, CDMA, UMTS, EV-DO, WiMAX, and/or LTE, 5G and/or one or more proprietary protocols developed for long distance communication, among other possibilities.

The balloons of FIG. 1 may be high-altitude balloons that are deployed in the stratosphere. As an example, in a high altitude balloon network, the balloons may generally be configured to operate at stratospheric altitudes, e.g., between 50,000 ft and 90,000 ft or more or less, in order to limit the balloons' exposure to high winds and interference with commercial airplane flights. In order for the balloons to provide desired coverage in the stratosphere, where winds may affect the locations of the various balloons in an asymmetrical or otherwise variable manner, the balloons may be configured to move latitudinally and/or longitudinally (transversely) by adjusting their respective altitudes, such that the wind carries the respective balloons to the respectively desired locations. Lateral propulsion may also be employed to affect a balloon's path of travel or to maintain time “on station” over a particular region.

### Example Balloon

FIG. 2A is an example balloon 200, which may represent any of the balloons 102 of balloon network 100. As shown, the balloon 200 includes an envelope 202 and a payload (e.g., a flight capsule) 204 connected to the envelope by a connection member 206 such as a down-connect or a tether. The balloon 200 may be configured, e.g., as a superpressure balloon and include one or more ballonets (not shown) to control buoyancy.

In a superpressure or other balloon arrangement, the envelope 202 may be formed from a plurality of gores 208 sealed to one another. An upper portion of the envelope 202 has an apex section configured for connection to an apex (or top) load ring or plate 210, and a lower portion having a base section configured for connection to a base load ring or plate 212 positioned at the bottom of the balloon envelope. Tendons (e.g., webbing or load tape) 214 are shown running longitudinally from the apex load ring 210 to the base load ring 212. The tendons are configured to provide strength to the gores and to help the envelope 202 withstand the load created by the pressurized gas within the envelope when the balloon is in use. There may be a 1:1 correspondence between the number of gores and the number of tendons. Alternatively, there may be more (or less) tendons than gores.

The envelope 202 may take various shapes and forms. For instance, the envelope 402 may be made of materials such as polyethylene, mylar, FEP, rubber, latex or other thin film materials or composite laminates of those materials with fiber reinforcements imbedded inside or outside. Other materials or combinations thereof or laminations may also be employed to deliver required strength, gas barrier, RF and thermal properties. Furthermore, the shape and size of the envelope 202 may vary depending upon the particular implementation. Additionally, the envelope 202 may be filled with different types of gases, such as air, helium and/or hydrogen. Other types of gases, and combinations thereof, are possible as well. Shapes may include typical balloon shapes like spheres and “pumpkins”, or aerodynamic shapes that are symmetric, provide shaped lift, or are changeable in shape. Lift may come from lift gasses (e.g., helium, hydrogen), electrostatic charging of conductive surfaces, aerodynamic lift (wing shapes), air moving devices (propellers, wings, electrostatic propulsion, etc.) or any hybrid combination of lifting techniques. One or more solar panels 216 may be arranged on or extending from the chassis of the payload 204.

As noted above, the payload 204 of balloon 200 may be affixed to the envelope 202 by a connection member 206, for instance a down-connect such as a cable or other rigid structure. FIG. 2B illustrates one example 250 of payload 204. As shown, the payload 204 may include a computer system such as control system 252, having one or more processors 254 and on-board data storage in memory 256. The payload 258 may also include various other types of equipment and systems to provide a number of different functions. For example, the payload 204 may include optical and/or RF communication systems 258, a navigation system 260, a positioning system 262, an altitude control system 264, a power supply 266 to supply power to various components of the payload 204, and a power generation system 268, which may include solar panels 216 as shown in FIG. 2A.

### Example Launch System

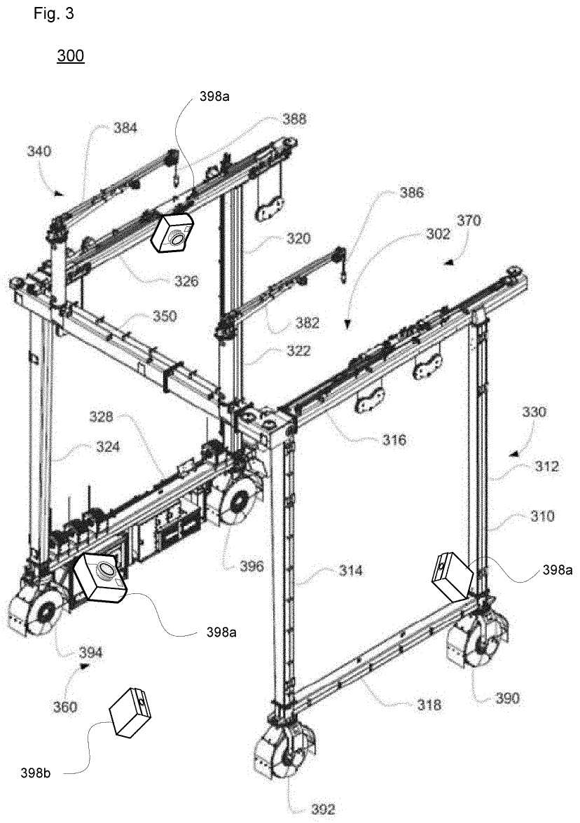

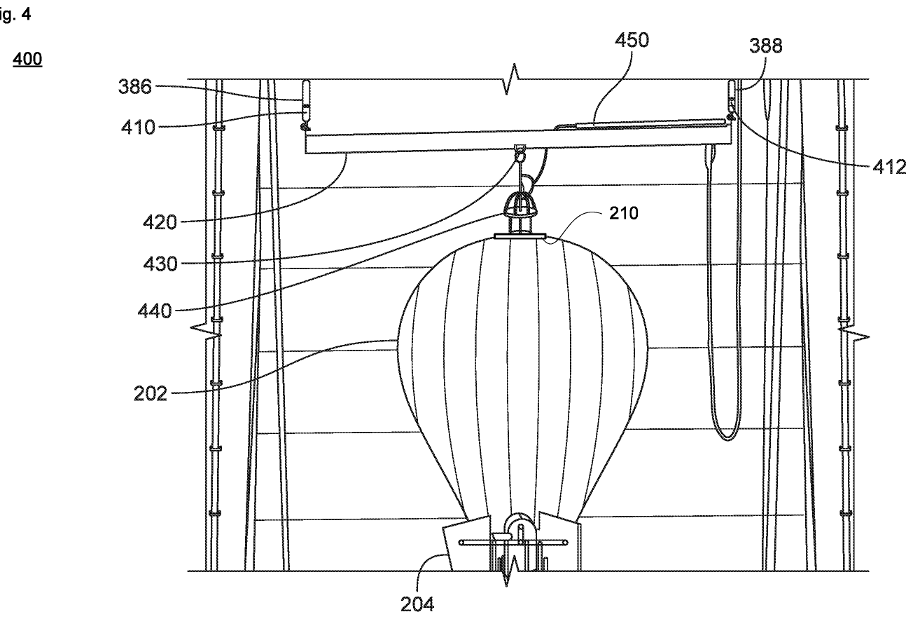

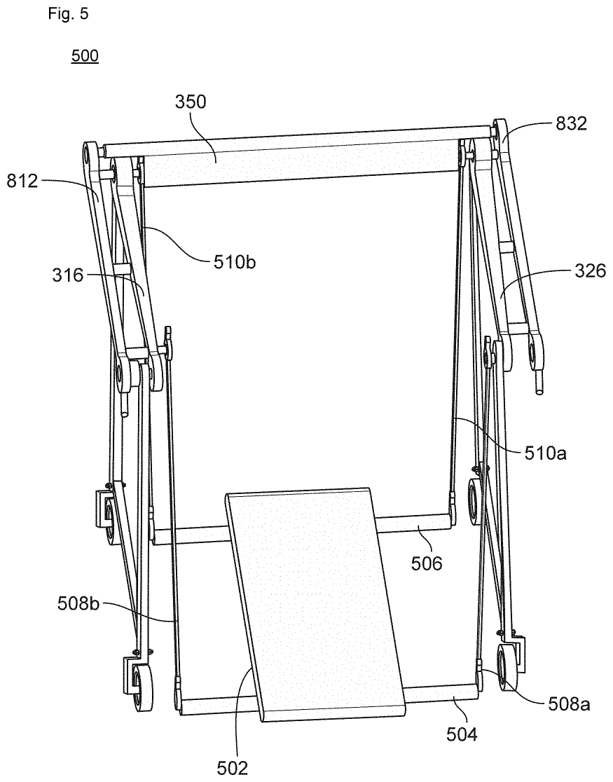

As shown in FIG. 3, an example PLR includes a support structure 300 surrounding an interior space 302 configured for inflating and launching of balloons. In one example, the support structure may be approximately 45 feet height, 35 feet wide and 40 feet in depth. The support structure 300 may include two rectangular supports 310, 320 on opposing left and right sides 330, 340, respectively, of the support structure. Each rectangular support includes two parallel side supports 312, 314, 322, 324, parallel top beams 316, 326, and parallel bottom beams 318, 328. In this regard, parallel side beams 312, 314, top beam 316, and bottom beam 318 form a first one of the rectangular supports. Similarly, parallel side beams 322, 324, top beam 326, and bottom beam 328 form a first one of the rectangular supports.

A lateral support beam 350 connects the rectangular support structures at the parallel side supports 314, 324 to one another on a third, back side 360 of the support structure. A fourth side 370 of the support structure 300 is framed by the two parallel side beams 312, 322 and is generally open in order to permit a balloon to be moved into and out of the support structure for inflating and launching.

The support structure may also include a one or more jib cranes for lifting and inflating of the balloons. In other words, the jib cranes operate to position the balloon and minimize movement prior to launch. In the example of FIG. 3, the support structure includes a first jib crane 382 and a second jib crane 384 mounted to a top surface of the lateral support beam 350. Each jib crane includes a cable 386, 388 that extends downward towards the interior space 302.

According to aspects of the technology, one or more cameras 398 are disposed on the PLR or otherwise adjacent to the launch area. For instance, camera(s) 398a may be affixed along the support structure at different locations or angles. Alternatively or additionally, camera(s) 398b may be separate from the PLR, for example arranged on the ground, mounted on another structure, carried by a human launch operator, situated on a truck, drone or other moveable platform, etc. The camera(s) 398 may be still or video cameras designed to capture optical imagery of the balloon during fill and launch. As discussed further below, the imagery and relevant metadata (e.g., timestamps, geographic location, pose and/or orientation of the camera, etc.) associated with the imagery are transmitted to a control system for processing in order to select an appropriate launch point (e.g., launch time, launch angle, etc.).

In one scenario, the camera(s) 398 may be supplemented or replaced by other sensors, such as laser (lidar) and/or ultrasonic (sonar) sensors, as well as laser rangefinders and optical fiducials, which can be used to identify and track specific points around the balloon.

As shown in illustration 400 of FIG. 4, at the end of each jib crane cable are connections 410, 412 for connecting to a beam or jib spreader 420. Each cable may be controlled by a corresponding hoist which may operate to extend and retract the cables 386, 388 of the first and second jib crane in order to lower and raise the jib spreader 420. In order to keep the jib spreader parallel with respect to the ground, the hoists may operate in unison or independently using a single controller.

In order to increase the range of movement of the jib spreader 420, the jib cranes may also be moveable in multiple degrees of freedom. For instance, each of the arms of the jib cranes may be extended or retracted towards and away from the lateral support beam 350 (or rather, moved up and down), using a hydraulics system. In this regard the jib spreader 420 may move up and down and even above the parallel top beams 316, 326 of the support structure.

The jib spreader 420 includes a mount 430 for connecting an assembly 440 for lifting a balloon. The assembly 440 may also be configured to provide lift gas into the balloon envelope through an opening in the top plate of the balloon. In that regard, electrical and lift gas lines 450 may be connected to the assembly 440 from the jib spreader 410 as shown in FIG. 4.

As noted above, in order to lift, fill and launch the balloons, a platform may be arranged within the interior space. FIG. 5 illustrates a platform assembly example 500. As shown, the platform assembly includes a platform 502 and two lateral support bars 504 and 506, which are each connected by two cables 508a-508b and 510a-510b, respectively, to a corresponding one of the parallel top beams 316, 326 of the support structure 300 of FIG. 3. Each cable 508 and 510 may be controlled by a corresponding hoist, which may be operated to extend and retract the corresponding cable in order to lower and raise lateral support bars 504, 506 towards and away from the parallel top beams 316, 326, thereby raising and lowering the platform.

In order to keep the platform 502 parallel with respect to the ground, the hoists may operate in unison or independently. The hoists used to raise and lower the platform may also be controlled with the single controller. In this regard, the cables can be used to raise and lower the platform completely independent of the cables of the jib cranes and/or in unison with the hoists of the jib cranes. In that regard, the movement of the jib cranes may be independent of or synchronized with the movement of the platform. Such operations can be employed in view of the data received from the camera(s) and/or other sensors, for instance to affect balloon tilt during fill or launch.

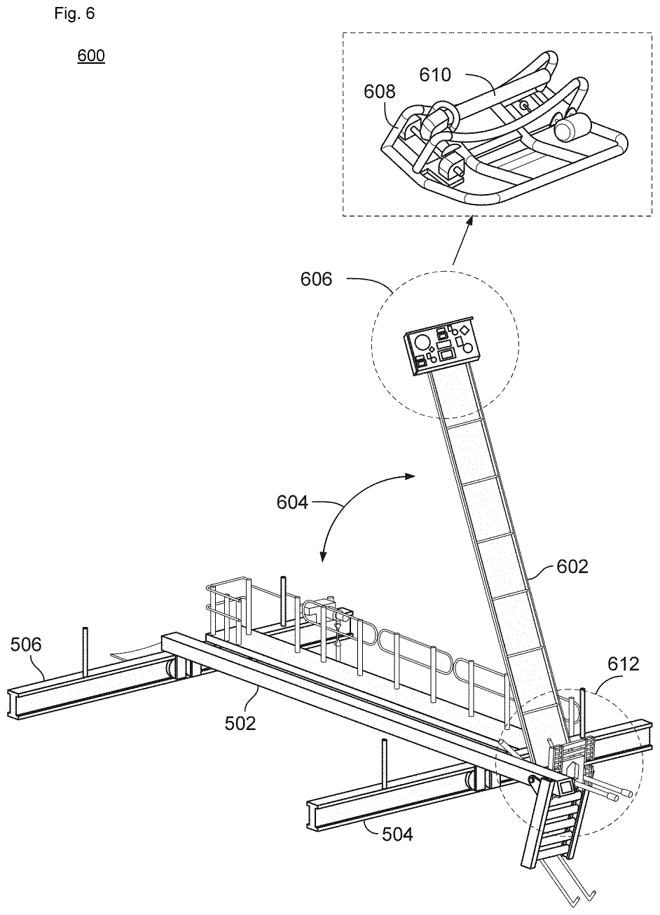

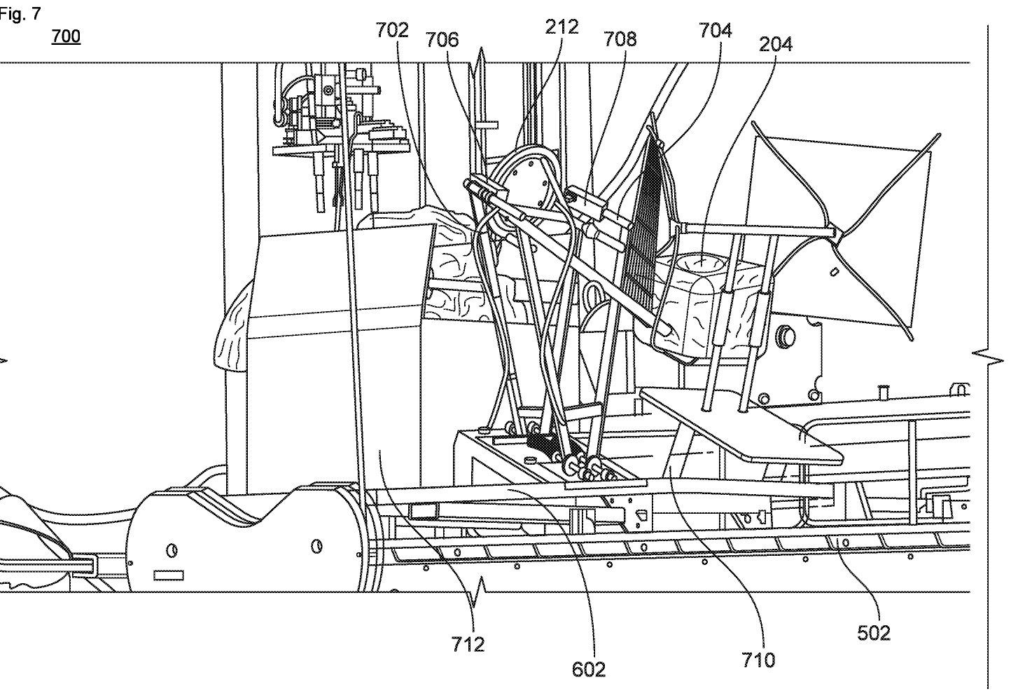

As shown in the example of FIG. 6, the platform 502 may be or may include a movable perch 602. The perch 602 can pivot relative to the platform 502 in the direction of arrows 604, using a hydraulics system (not shown), in order to lift the balloon during inflation as well as to move and lift the balloon during launch. A first end 606 of the perch includes a releasable restraint 608 for holding a portion of the balloon envelope to the perch during inflation and prior to launch. The releasable restraint includes a roller bar 610 which allows material of the balloon envelope to slide within the releasable restraint 608 without pulling on or damaging the material. In addition, the releasable restraint may 608 be configured to move along the perch 602 in order to assist an operator in positioning the balloon envelope on the perch.

A second end 612 of the perch 602 may be configured for attachment with the payload of a balloon. For example, the second end may include or be attached to a payload positioning assembly, as shown in example 700 of FIG. 7, which includes two arms 702, 704 having end portions 706, 708 which are configured to clamp onto a portion of the balloon as well as a rest structure 710 for holding the payload prior to launch. The payload positioning assembly may position or maintain the position of the payload until the releasable restraint has been released and the balloon envelope has reached a certain height or location relative to the payload where the payload is ready to be released. This reduces the likelihood that the payload will collide with the perch, platform, or ground after the payload is released during a launch. As shown, a box or other housing 712 stores the uninflated balloon in the payload positioning assembly.

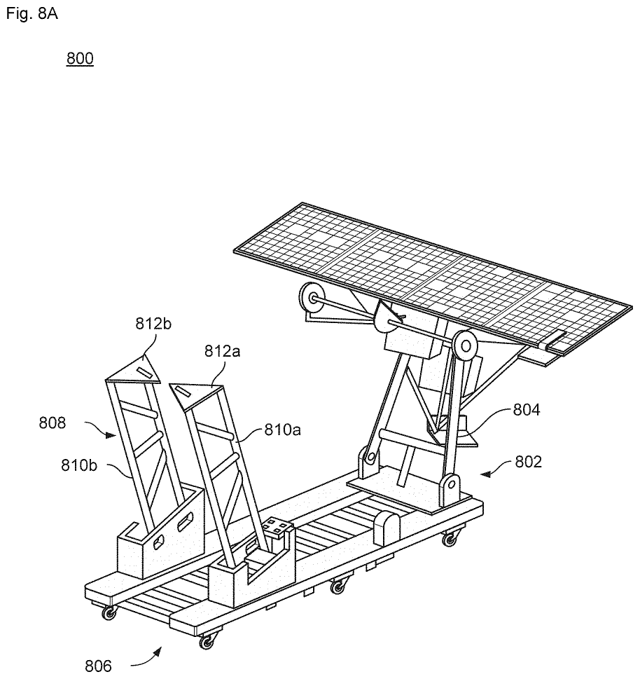

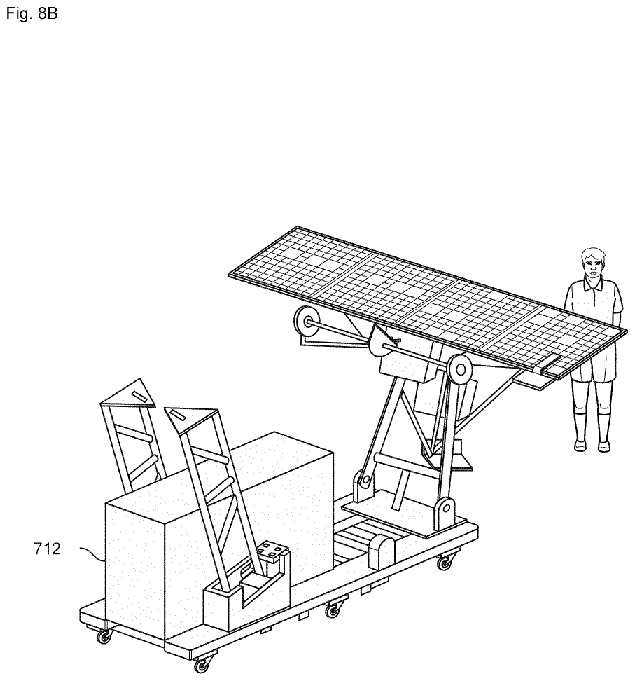

As shown in the example of FIG. 8A, one end 802 of a cart 800 may include a rest structure 804 for holding the balloon's payload to the perch during inflation and prior to launch. As shown in FIG. 8B, the cart 800 is sized to hold box 712 including a balloon. In this regard, the box 712 may be placed on the cart at one location (such as a warehouse, storage location, etc.), and the cart may be used to move the box towards the support structure. Once in position, the cart may be connected to the perch 602.

Returning to FIG. 8A, second end 806 of the cart 800 may include a payload positioning assembly 808 including two arms 810a, 810b having end portions 812a, 812b which are configured to clamp onto a portion of the balloon. Payload positioning assembly 808 may position or maintain the position of the payload until the releasable restraint has been released and the balloon envelope has reached a certain height or location relative to the payload where the payload is ready to be released. This reduces the likelihood that the payload will collide with the perch, platform, or ground after the payload is released during a launch. In one example, one of the cameras may be located on or adjacent to the cart 800.

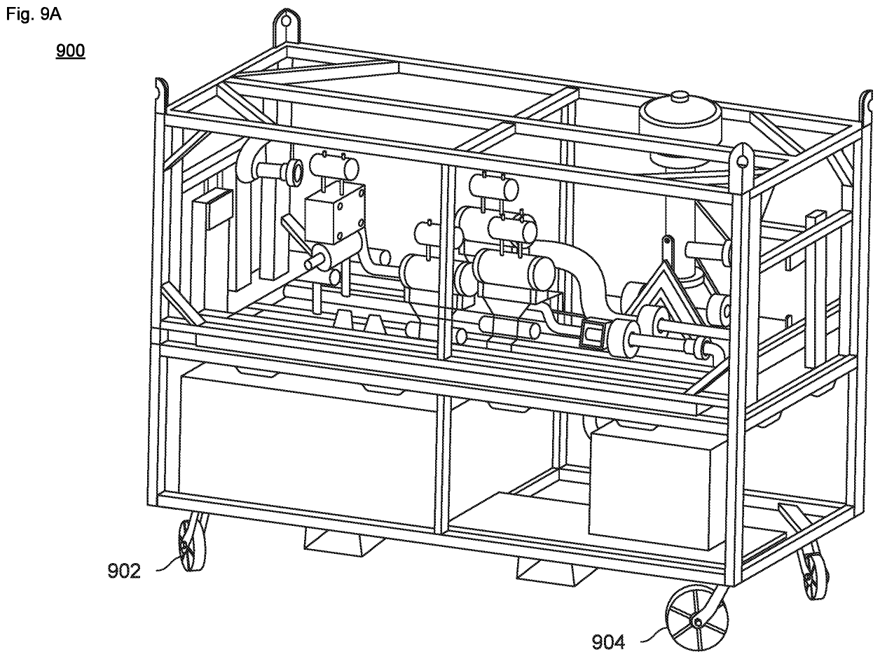

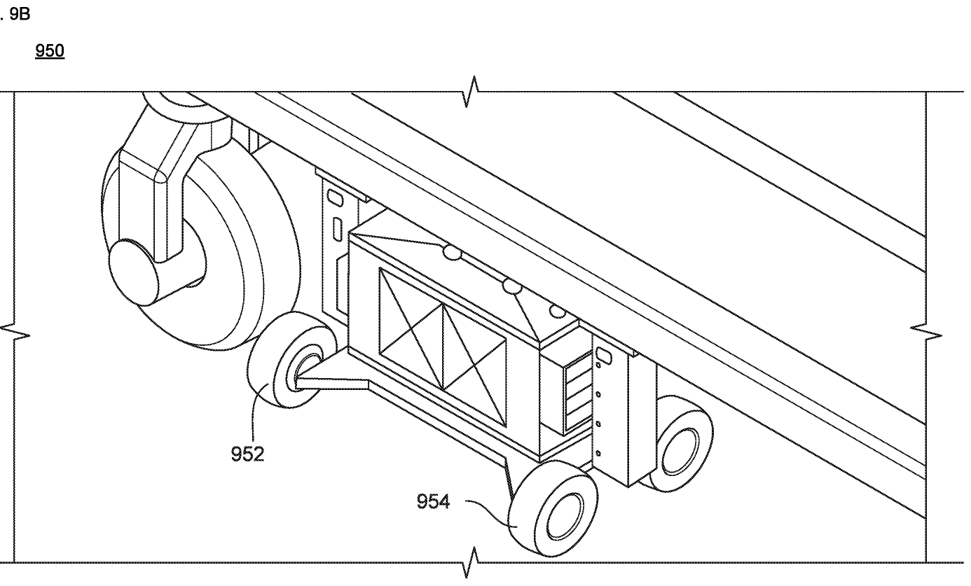

As noted above, the PLR may be used not only to launch a balloon, but also the fill the balloon. In this regard, a lift gas supply may be provided. The lift gas supply may be integrated into the support structure 300, in order to reduce the likelihood of kinking of the lift gas supply line when the support structure is moved. Alternatively, the lift gas supply may be an independent assembly, such as one of the lift gas supply carts 900 or 950 as shown in FIGS. 9A and 9B, respectively. Again, in order to reduce kinking of the lift gas supply line when the support structure is moved, the lift gas supply cart may be configured to connect and move with the support structure. When connected, the lift gas supply cart may include a gas supply that can connect with the lift gas line in order to fill a balloon envelope with lift gas. Because the supply carts 900 and 950 include wheels 902, 904 or 952, 954, respectively, when needed, one of these lift gas supply carts may be wheeled over to the support structure and connected to the lift gas line.

The lift gas supply cart may include a supply of lift gases, such as hydrogen and/or helium, as well as various metering devices which provide for highly accurate metering of the amount of lift gas in the balloon envelope during inflation. The lift gas supply cart may also be configured to provide lift gas to the balloon envelope at very high rates of speed and a range of temperatures, such as between −20 degrees C. to 50 degrees C.

The PLR is also configured to change the position and orientation of the support structure. For instance, returning to FIG. 3, each of the bottom beams 318, 328 may include two or more wheels 390, 392 and 394, 396, respectively. Each wheel may include an independent hydraulics or gear drive system to turn (angle) and rotate (drive) that wheel. The independent movement of each wheel allows the PLR to have many different types of movement such as 2-wheel and 4-wheel drive modes. By changing the orientation of the wheels, the PLR can always be maneuvered such that the fourth open side of the PLR can be rotated to downwind as wind conditions at a launch site change.

The various features of the PLR may be electrically connected to a control system. For instance, user inputs such as a controller, may be included within a cab of the PLR sized to accommodate an operator. These user inputs may allow the operator to communicate with the control system in order to control the movement and position of the wheels 390, 392, 394, 396, platform 502, perch 602, releasable restraint 608, jib cranes 382 and 384, hangar doors, as well as other components of the PLR.

The operator need not rely only on visible observation of the state of the PLR and wind conditions; rather, the PLR may include a data acquisition system. The data acquisition system may include various sensors arranged to detect the position and location of the wheels 390, 392, 394, 396, platform 502, perch 602, releasable restraint 608, the payload positioning assembly, jib cranes 382 and 384, the hangar doors, as well as the camera(s) 398, wind sensors and other equipment used to evaluate the position and orientation of the balloon envelope prior to launch.

In one scenario, the PLR includes a set of cameras to provide a 3D view of the balloon envelope, as well as sensors configured to detect and provide information regarding current wind conditions outside of the PLR and also within the interior space 302. In addition, the control system may also communicate with the lift gas supply cart 900 or 950 to control the inflating of the balloon envelope. These sensors may send information to the control system which processes the information and, optionally, provides it for display, for example, on an electronic display (not shown) within the cab, to the operator.

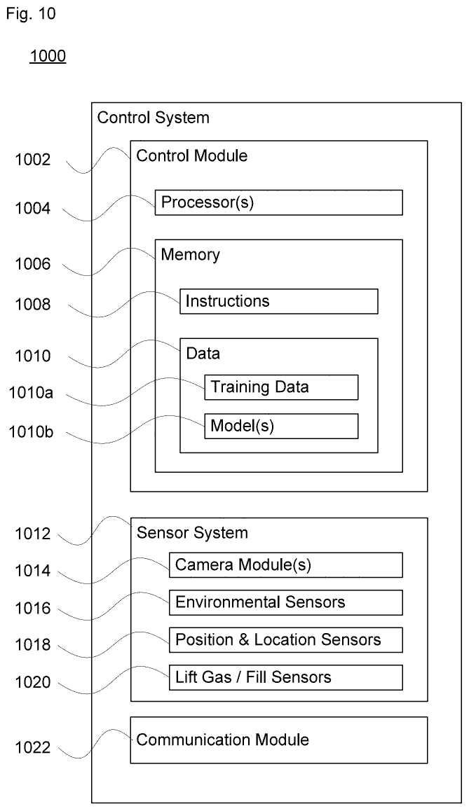

FIG. 10 illustrates an example control system 1000 configured to manage fill and launch, for instance in response to load cell measurements and other data obtained by the various components and sensors of the PLR. In this regard, the control system 1000 may have a control module 1002 including one or more processors 1004, memory 1006, as well as other components typically present in general purpose computing devices. The one or more processors 1004 may be any conventional processors, such as commercially available CPUs. Alternatively, the one or more processors 1004 may be a dedicated device such as an ASIC or other hardware-based processor. The memory 1006 is configured to store information accessible by the one or more processors, including instructions 1008 and data 1010 that may be executed or otherwise used by the processor(s) 1004. The memory may be of any type capable of storing information accessible by the processor, including a non-transitory computer-readable medium or other non-transitory medium that stores data that may be read with the aid of an electronic device, such as a hard-drive, memory card, ROM, RAM, DVD or other optical disks, as well as other write-capable and read-only memories. The processor(s), control module, or memory may actually include multiple processors, control modules, or memories that may or may not be stored within the same physical housing.

The instructions 1008 may be any set of instructions to be executed directly (such as machine code) or indirectly (such as scripts) by the processor. For example, the instructions 1008 may be stored as computing device code on the computer-readable medium. The instructions 1008 may be stored in object code format for direct processing by the processor, or in any other computing device language including scripts or collections of independent source code modules that are interpreted on demand or compiled in advance. The data 1010 may be retrieved, stored or modified by processor(s) 1004 in accordance with the instructions 1008. By way of example, the data 1010 may include training data 1010a and/or models 1010b, for use in aiding the control system 1000 via machine learning to determine suitable conditions for launch in accordance with the imagery and wind data received from various sensors.

As shown, the control system 1000 may also include sensor system 1012 that includes one or more camera modules 1014 (and/or lidar, ultrasonic or other sensors) to obtain imagery and other data about the balloon, environmental sensors 1016 to measure wind, temperature, humidity, etc., position and location sensors 1018 to measure the position and orientation of the PLR, balloon assembly and other components (including the camera modules), and lift gas or fill sensors 1020, for instance to measure the flow rate and volume of gas in the envelope.

In addition, the control system 1000 may include a communication module 1022 configured to send information to the ground crew and/or to a remote computer via a communication link, for instance so that an operator outside of the cab may still be able to control the movement and position of the wheels, platform, perch, releasable restraint, payload positioning assembly or the features of the cart, jib cranes, the hangar doors, as well as various other features of the PLR. For example, this communication link can be a wired or wireless link that uses several kinds wireless communication protocols, such as WiFi, Bluetooth or other protocols. As with control system 1000, the remote computer may include a processor and memory storing data and instructions as discussed above.

In one scenario, the control system 1000 operates autonomously. That is, rather than having an operator control the various aspects of balloon fill and/or launch, the control system may use the data from the various sensors to automatically control the movement and position of the wheels, platform, perch, releasable restraint, payload positioning assembly or the features of the cart, jib cranes, the hangar doors, as well as various other features of the PLR according to its instructions and in view of the position and orientation of the balloon envelope. For example, rather than having an operator adjust the position (height) of the platform or the jib cranes, the control system may adjust its position automatically according to the instructions of the control system's memory. The control system may also determine when to launch the balloon based on the positioning of the envelope, wind speed and direction, etc. Of course, for safety reasons, the control system may be controlled in a manual mode by an operator either within the cab or remotely at any time.

### Example Balloon Positioning, Inflating and Launching

As noted above, the PLR may be used to lift, fill and launch a balloon. In order to do so, at least a portion of the balloon may be positioned within the interior space of the PLR. As shown in FIG. 7, the box 712 containing the balloon envelope 202 may be placed on the perch 602 within the interior space. The payload 204 may be placed on the rest structure 804 (FIG. 8A) and the end portions 706, 708 of arms 702, 704 may be clamped onto the base plate 212. In addition, the roller bar 610 of the releasable restraint 608 may be clamped onto the balloon envelope 202 and slid towards the first end 612 of the perch 602 (FIG. 6) and into the interior space.

In order to lift the balloon envelope 202 out of the box 712, the jib spreader may be positioned over and lowered towards the box. As indicated above, this may be achieved by positioning the first and second arms of the jib cranes and extending the cables 386 and 388. The assembly 440 for lifting the balloon may then be secured to the top plate 210. The hoists of the jib cranes of may then retract the cables 386, 388 in order to raise the jib spreader 420 and pull the balloon envelope out of the box. Prior to or once the assembly 440 is secured to the top plate 210, a lift gas supply cart may be wheeled over to the support structure and connected to the lift gas line 450.

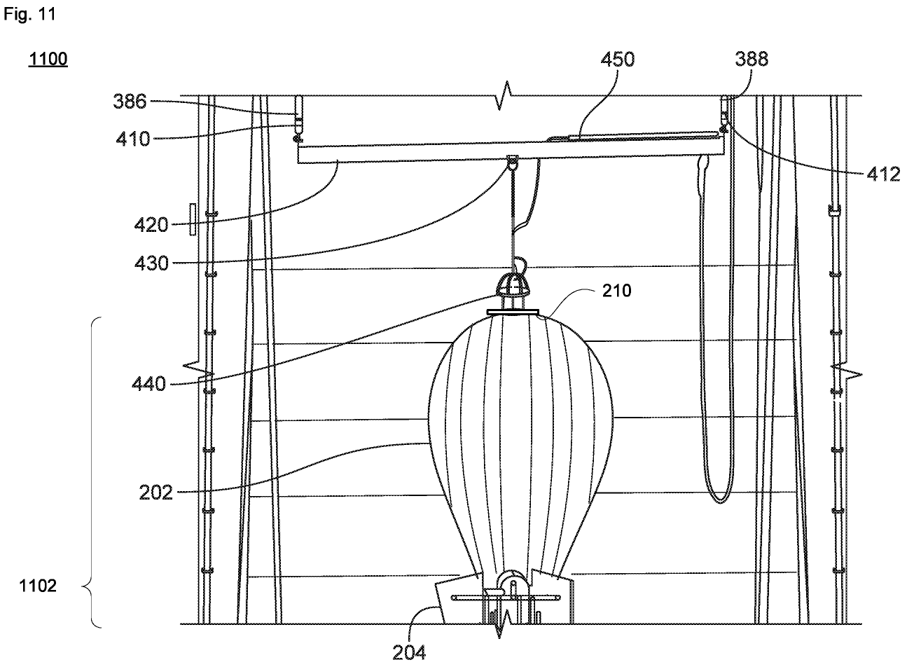

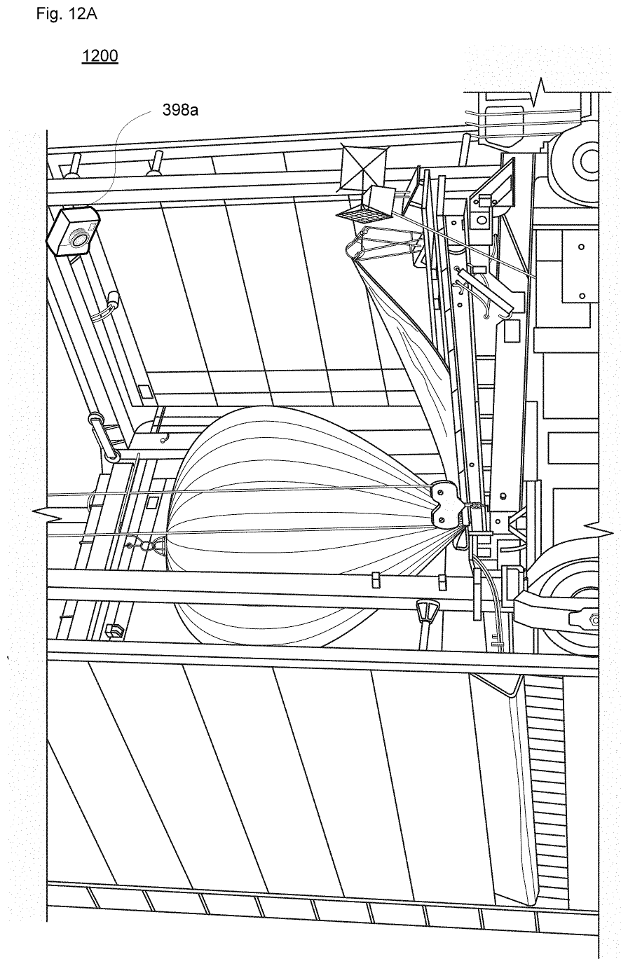

FIG. 11 illustrates an example view 1100 after the assembly 440 is secured to the top plate 210, the lift gas line has been connected. As shown, an initial amount of gas has flowed into the balloon envelope 202 so that it is partially filled. Here, the envelope extends a vertical distance 1102 upward from the box (omitted for clarity). In this example, as the envelope is inflated, the jib spreader 420 attached to the top plate 210 may be adjusted in height (e.g., by decreasing the distance between the jib spreader and the top plate). Lift gas from the supply cart may flows into the balloon envelope 202 via the lift gas line 450 and assembly 440 until the filling is complete and the desired inflation pressure is reached within the balloon envelope.

Once the fill process has reached the point where the envelope has enough lift gas to bring the balloon and its payload to a desired altitude in the stratosphere, the filling is stopped, the lift gas line 450 is disconnected from the top plate 210 and the balloon is readied for launch. For instance, the releasable restraint may be configured to release the balloon components so that the balloon can move further into the air. In an alternative configuration, one or both of the releasable restraint or the launch cart may be omitted.

Prior to, during and after the inflation, the features of the PLR may be moved in order to obtain the best possible launch conditions within the interior space as wind conditions around the PLR change. For example, hangar doors may be lowered to reduce the wind within the interior space from the direction of the left side 330, back side 360, and right side 340 of the support structure. Even in situations where the direction of the wind changes, the drive and steering examples above may be used to change the position of the PLR so that the front side 370 is downwind. This can even further reduce the amount of wind within the interior space.

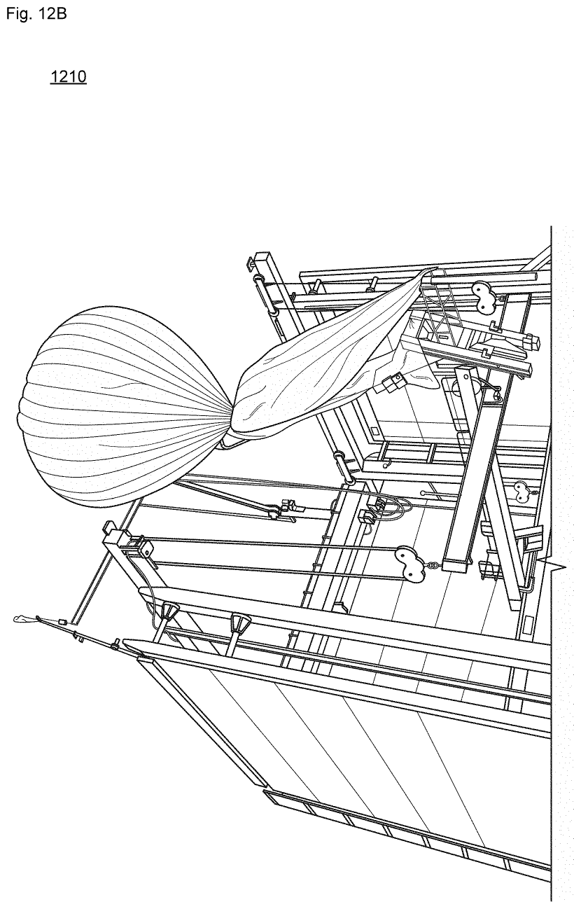

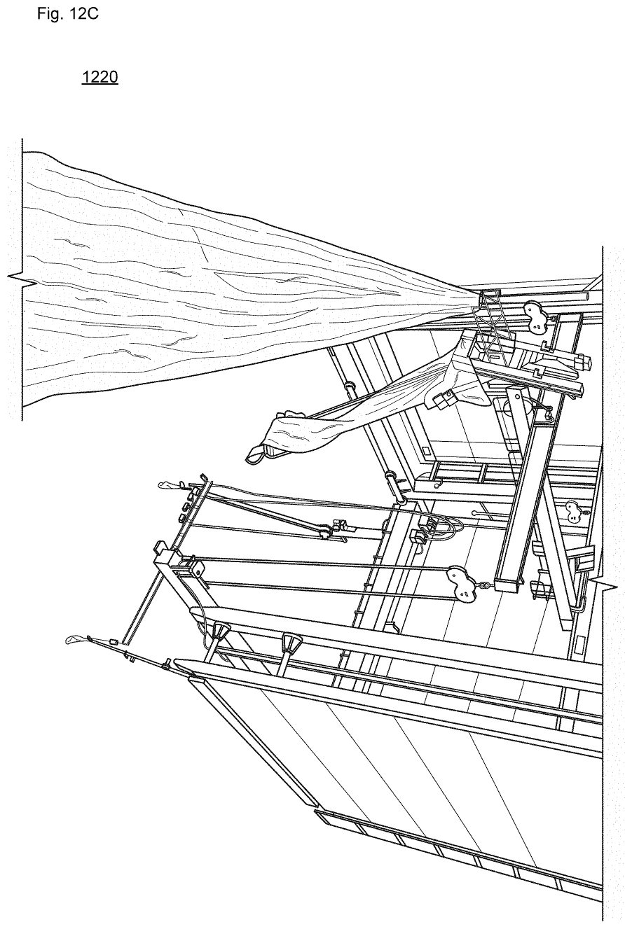

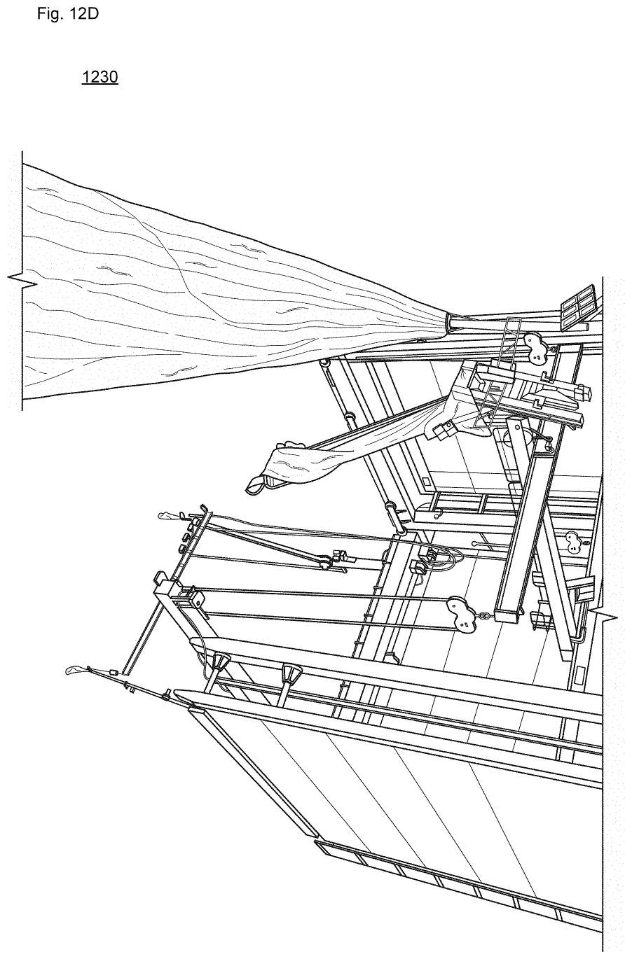

Once the inflating is complete and the PLR (and platform, etc.) are positioned for the current wind conditions where the fourth side 370 is positioned downwind, the balloon 200 may be ready for launch. FIG. 12A illustrates a view 1200 where the filling is complete, or the desired inflation pressure has been reached within the balloon envelope. A camera 398a on the PLR may obtain imagery throughout the fill process, and continue taking imagery of the balloon envelope regularly (e.g., every 0.1-5.0 seconds, or more or less) or continuously until launch. While only one camera is shown in this figure, any number of cameras may be employed, for instance to provide a full 3D view of the balloon envelope relative to the payload, PLR and/or other equipment. The cameras enable the system to detect not only the 3D position of the balloon, but also to detect movement trends based on current and predicted localized wind patterns.

Upon fill completion, the fill tube from the lift gas line is crimped. Then the top plate 210 may be released from the assembly 440. At the same time or shortly thereafter, the assembly may be pulled away from the top plate 210 (via the jib cranes 382, 384). This may reduce the likelihood of damage to the balloon envelope from hitting the assembly 440 or jib spreader 420 during launch.

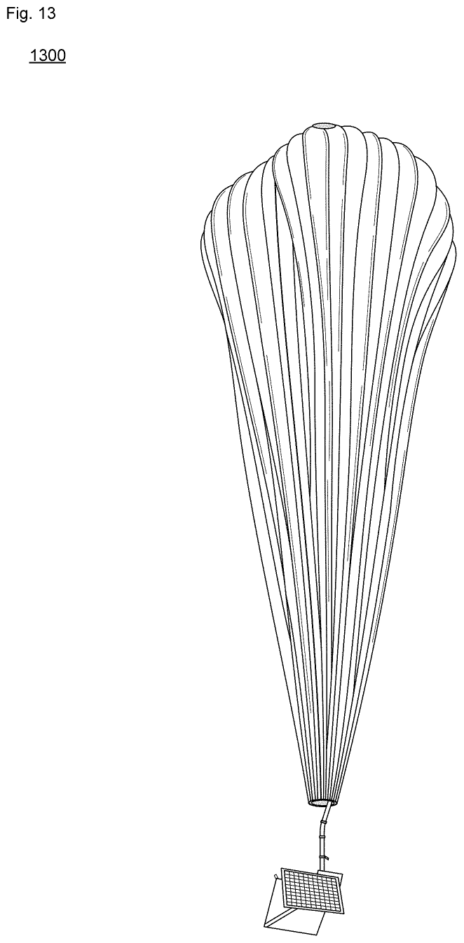

At launch, the first end of the perch is swung upwards as shown in view 1210 of FIG. 12B. Next, the balloon envelope is released from the releasable restraint by swinging the roller bar away from the releasable restraint. This causes the balloon envelope to begin to rise away from the first end of the perch as shown in view 1220 of FIG. 12C. At an appropriate time thereafter, such as when the balloon envelope has passed over (or beyond) the payload, the end portions of the connector arms may be released from the envelope base plate. As shown in view 1230 of FIG. 12D, the arms may swing away from the base plate, thereby allowing the balloon (including the payload) to float away and complete the launch. FIG. 13 illustrates a post-launch view 1300 of the balloon as it ascends to the stratosphere.

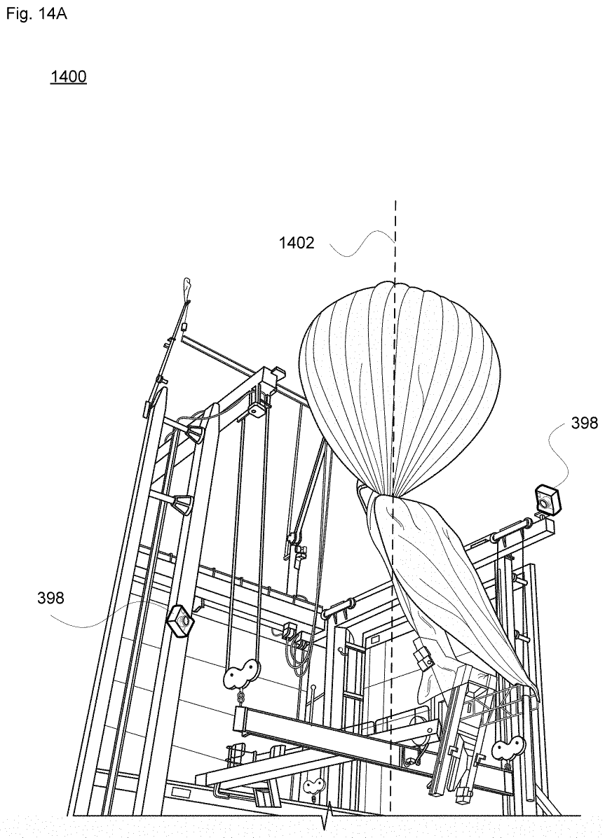

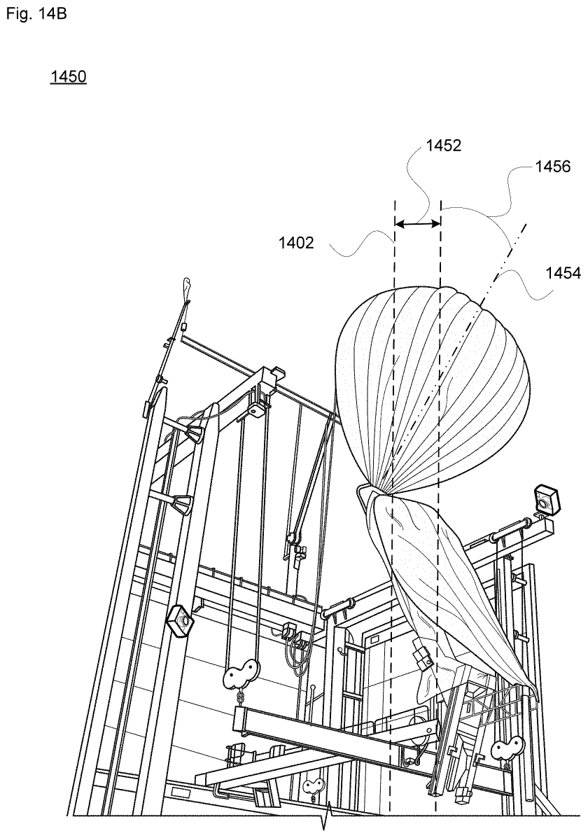

Returning to the launch process, once fill has been completed and the fill tube has been crimped or removed from the balloon envelope, the control system evaluates the position and orientation of the envelope, wind conditions and other factors in order to decide an appropriate time to launch. This includes the control system evaluating received imagery in real time, for instance from cameras positioned around the launch area. FIG. 14A illustrates one example 1400 in which the cameras 398 are positioned on the PLR. As shown by dashed line 1402, the position of the apex of the balloon, e.g., the top plate/load ring, may be measured relative to some predetermined baseline such as a fixed anchor point. In particular, FIG. 14B illustrates a situation 1450 in which the apex or top plate has moved laterally from the baseline as shown by arrow 1452. In addition, as shown by dash-dot line 1454, the apex or top plate is now tilted at some non-zero angle 1456 relative to vertical. Alternatively or additionally, the position and angle of the base of the balloon envelope may be evaluated relative to another point, such as relative to the payload or to a portion of the PLR itself.

As noted above, the camera(s) should be arranged to provide a full 3D view of the balloon. The imagery may identify the silhouette or edge of the balloon, and/or different points on or features of the balloon, such as the gores, top and base plates, tendons, etc. This information may be used by the control system to determine the rms or geometric center of the balloon, as well as the balloon's geometry and position with respect to the PLR and payload. The geometry may be, by way of example only, in x,y,z coordinates or some other coordinate system may be employed. The tilt may be measured, e.g., in degrees or radians. Information from the wind sensors can provide the current and expected wind speed and direction. As described further below, such information can be employed by the control system to determine the optimum launch or release angle for the balloon. Upon launch, the system may monitor velocity, acceleration and position of the balloon and payload relative to the PLR. Once the HAP clears the PLR, the system may continue to monitor the launch for as long as possible, for instance to gather data regarding successful (and unsuccessful) launches. In conjunction with the launch, the control system may notify the ground crew and/or other launch team members about an imminent launch, for instance in the next 10-30 seconds, or more or less. Visual, audible and/or electronic messages may be provided via the communication module to alert the crew and any remote systems about the launch.

As noted above, the control system may use a machine learning approach to determine suitable conditions for launching the HAP. By way of example, one or more models may be developed according to selected parameters and model definitions. This can include any inputs (e.g., images from the camera(s), lidar point clouds from a lidar sensor and/or acoustical data from one or more ultrasonic sensors) and outputs (e.g., objects recognized from the images, lidar point clouds and/or acoustical data) of the model. The definitions may include one or more parameters (e.g., size, shape, tilt) for generating the outputs using the inputs, and weights for these parameters (e.g., tilt of the object is given more weight than its shape). The definitions may also include a type of the model (e.g., neural network) and properties specific to the type of model (e.g., number and properties of layers for the network). The training data may be raw data (e.g., captured images, received lidar point cloud information and/or acoustical data) that had been reviewed by an operator and manually labeled by the operator (e.g., objects recognized in the images).

Additionally, there may be user inputs including instructions for pre-processing or post-processing the training data. Pre-processing may include applying transformations, filters, normalizations, etc., to the training data. For example, raw images, lidar point clouds and/or acoustical data may be filtered and normalized before being used for training a model to recognize objects (e.g., balloon envelopes, payloads, etc.) from images. Pre-processing may further include splitting the training data into a training data set for training the model, and a testing data set for testing performance of the model. The inputs may also include metrics for evaluating the training results. For instance, the metrics may include thresholds for launch, confidence levels, etc. By way of example, after training, each trained copy of the model may be evaluated using the metrics specified by the developer or other user. The model may be updated based on information received from balloon launches, including pre- and post-launch imagery.

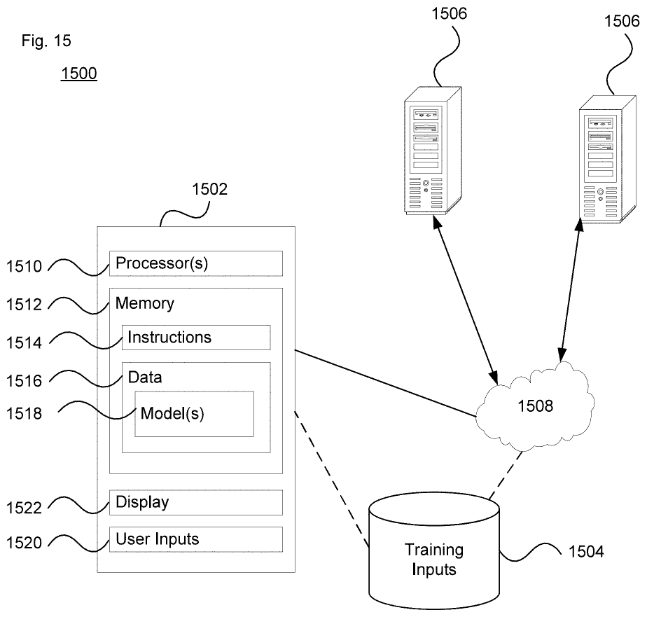

FIG. 15 illustrates one example 1500 of a system to create a balloon launch model in accordance with aspects of the technology. Device 1502 may be a computer device (e.g., desktop or laptop computer) used by a developer or other user to create the model. As indicated by the dashed lines, training inputs (training data) from database 1504 may be provided to one or both of the user device 1502 and/or other computer devices 1506 via network 1508. As shown, the device 1502 includes one or more processors 1510, memory 1512 and other components typically present in general purpose computing devices. The memory 1512 stores information accessible by the one or more processors 1510, including instructions 1514 and data 1516 that may be executed or otherwise used by the processor 1510. The memory 1512 may be of any type capable of storing information accessible by the processor, including a computing device-readable medium. The memory is a non-transitory medium such as a hard-drive memory card, optical disk, solid-state, tape memory, or the like. Devices may include different combinations of the foregoing, whereby different portions of the instructions and data are stored on different types of media.

The instructions 1514 may be any set of instructions to be executed directly (such as machine code) or indirectly (such as scripts) by the processor. The instructions may be stored in object code format for direct processing by the processor, or in any other computing device language including scripts or collections of independent source code modules that are interpreted on demand or compiled in advance. The data 1516, including model(s) 1518, may be retrieved, stored or modified by one or more processors 1510 in accordance with the instructions 1514, for instance as described above with regard to the control system of FIG. 10.

The one or more processor 1510 may be any conventional processors, such as commercially available CPUs. Alternatively, the one or more processors may be a dedicated device such as an ASIC or other hardware-based processor. Although FIG. 15 functionally illustrates the processor(s), memory, and other elements of the device 1502 as being within the same block, such devices may actually include multiple processors, computing devices, or memories that may or may not be stored within the same physical housing. Similarly, the memory 1512 may be a hard drive or other storage media located in a housing different from that of the processor(s) 1510, such as in training inputs database 1504. Accordingly, references to a processor or computing device will be understood to include references to a collection of processors or computing devices or memories that may or may not operate in parallel.

The device 1502 may include all of the components normally used in connection with a computing device such as the processor and memory described above as well as a user interface subsystem. The user interface subsystem may include one or more user inputs 1520 (e.g., a mouse, keyboard, touch screen and/or microphone) and one or more electronic displays 1522 (e.g., a monitor having a screen or any other electrical device that is operable to display information). Output devices besides the electronic display 1522, such as speaker(s) (not shown), may also be part of the device 1502. The user may build and store the one or more models 1518 in the data portion of memory 1512. By way of example only, the model may be for a lighter-than-air HAP in general, a dynamic model of a balloon envelope during fill, a launch configuration, etc.

The training inputs 1504 may include various information associated with the HAP, its components (e.g., payload weight, envelope shape or volume, envelope material(s), etc.), environmental conditions, location information and other factors. By way of example, the training inputs 1504 can include raw images, lidar point clouds and/or acoustical data indicating balloon position, shape, tilt, etc. They can also include wind data, such as current and predicted wind speed and direction (wind vectors) at various points about the HAP or the launch facility. Orientation and positioning of the launch system relative to the wind direction could also be included. The training inputs may additionally include records or examples from prior launches, including the position and acceleration of the balloon immediately before or after launch (e.g., 0.1-2.0 seconds before or after), as well as post-launch data in the seconds or minutes after launch. The inputs may also include whether certain launch conditions resulted in success (e.g., the HAP functioned as predicted for a selected period of time) or failure (e.g., the HAP failed to stay aloft or perform certain operations based on predefined operational criteria).

Outputs generated in accordance with the model may include information about how long the HAP operated in the stratosphere or whether the envelope burst upon launch. This information may be correlated to the positioning and other data about the HAP (e.g., envelope shape/volume, payload weight, etc.) and about the PLR arrangement given the current (and/or predicted) wind conditions, and used by the system to identify optimal launch criteria, such as when to launch in view of the tilt angle, wind vector data, etc. Some of all of this information may be stored locally by the control system discussed with regard to FIG. 10. It may also be stored remotely on a back end system that provides the model(s) to the control system. The control system is able to use the model(s) to determine an optimal time to launch the HAP, for instance based on a threshold confidence level (e.g., 98% or more) that the launch will be successful. As a result, the control system may autonomously launch the HAP at the proper time, including activating the releasable restraint, thereby reducing the likelihood of human error that could adversely impact the launch.

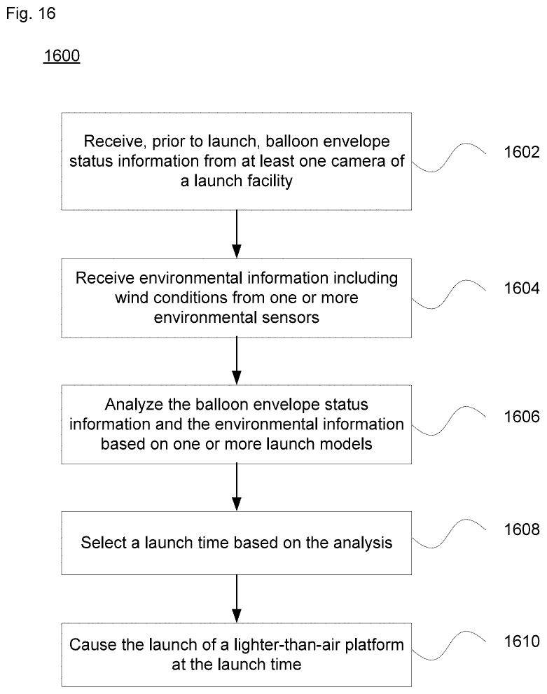

FIG. 16 illustrates a flow diagram 1600 in accordance with some of the aspects described above. In particular, for a method of launching a lighter-than-air platform for operation in the stratosphere at a launch facility. At block 1602 the method includes receiving, prior to launch by one or more processors of a control module, balloon envelope status information from at least one camera located at the launch facility. The balloon envelope is part of a lighter-than-air platform that also includes a payload. At block 1604, environmental information is received including current wind conditions from one or more environmental sensors. At block 1606, the balloon envelope status information and the environmental information are analyzed based on one or more launch models. At block 1608, a launch time is selected based on the analysis. And at block 1610, the lighter-than-air platform is launched from the launch facility at the selected launch time.

Aspects, features and advantages of the disclosure will be appreciated when considered with reference to the foregoing description of embodiments and accompanying figures. The same reference numbers in different drawings may identify the same or similar elements. Furthermore, the following description is not limiting; the scope of the present technology is defined by the appended claims and equivalents. While certain processes in accordance with example embodiments are shown in the figures as occurring in a linear fashion, this is not a requirement unless expressly stated herein. Different processes may be performed in a different order or concurrently. Steps may also be added or omitted unless otherwise stated.

Most of the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. As an example, the preceding operations do not have to be performed in the precise order described above. Rather, various steps can be handled in a different order or simultaneously. Steps can also be omitted unless otherwise stated. In addition, the provision of the examples described herein, as well as clauses phrased as “such as,” “including” and the like, should not be interpreted as limiting the subject matter of the claims to the specific examples; rather, the examples are intended to illustrate only one of many possible embodiments.

1. A method of launching a lighter-than-air platform for operation in the stratosphere, the lighter-than-air platform including a balloon envelope and payload, the method comprising:
receiving prior to launch, by one or more processors of a control module, balloon envelope status information from at least one camera located at a launch facility;
receiving, by the one or more processors, environmental information including current wind conditions from one or more environmental sensors;
analyzing, by the one or more processors, the balloon envelope status information and the environmental information based on one or more launch models;
selecting, by the one or more processors based on the analyzing, a launch time; and
causing the lighter-than-air platform to be launched at the launch time.

2. The method of claim 1, wherein the balloon envelope status information includes at least one of a fill status, an envelope volume status or tilt information.

3. The method of claim 1, wherein the method further comprising:
receiving, by the one or more processors, fill status information; and
selecting the launch time is based on the fill status information.

4. The method of claim 1, wherein the one or more launch models are stored in memory of the control system.

5. The method of claim 1, further comprising the one or more processors adjusting one or more of a position, orientation or wind protection of a launch rig prior to selecting the launch time.

6. The method of claim 1, wherein receiving the balloon envelope status information from the at least one camera includes obtaining a 3D view of the balloon envelope relative to the payload.

7. The method of claim 6, wherein obtaining the 3D view of the balloon envelope includes obtaining imagery of the balloon envelope relative to a launch rig at least partly enclosing the lighter-than-air platform.

8. The method of claim 1, further comprising the one or more processors determining an rms or geometric center of the balloon envelope based on imagery received from the at least one camera.

9. The method of claim 1, further comprising:
receiving additional sensor information from at least one of a lidar sensor or an ultrasonic sensor;
wherein analyzing the balloon envelope status information is further based on the additional sensor information.

10. The method of claim 1, wherein the current wind conditions include wind vectors at one or more locations about the launch facility.

11. The method of claim 1, further comprising the at least one camera capturing post-launch imagery of the lighter-than-air platform.

12. The method of claim 11, further comprising updating the one or more launch models based on the post-launch imagery.

13. A control system for initiating launching a lighter-than-air platform for operation in the stratosphere, the lighter-than-air platform including a balloon envelope and payload, the control system comprising:
a sensor system including one or more camera modules and one or more environmental sensors located at a launch facility;
memory storing one or more launch models; and
one or more processors operatively coupled to the sensor system and the memory, the one or more processors being configured to:
receive, prior to launch, balloon envelope status information from the one or more camera modules;
receive environmental information including current wind conditions at the launch facility from the one or more environmental sensors;
analyze the balloon envelope status information and the environmental information based on one or more launch models;
select, based on the analyzing, a launch time; and
cause the lighter-than-air platform to be launched at the launch time.

14. The control system of claim 13, wherein the balloon envelope status information includes at least one of a fill status, an envelope volume status or tilt information.

15. The control system of claim 13, wherein the one or more processors are further configured to adjust one or more of a position, orientation or wind protection of a launch rig prior to selecting the launch time.

16. The control system of claim 13, wherein the one or more camera modules are configured to obtain a 3D view of the balloon envelope relative to the payload.

17. A launch system for launching a lighter-than-air platform for operation in the stratosphere, the lighter-than-air platform including a balloon envelope and payload, the launch system comprising:
a launch rig positioned at a launch facility, the launch rig including a support structure surrounding an interior space configured to receive the lighter-than-air platform; and
a control system comprising:
a sensor system including one or more camera modules and one or more environmental sensors located at the launch facility;
memory storing one or more launch models; and
one or more processors operatively coupled to the sensor system and the memory, the one or more processors being configured to:
receive, prior to launch, balloon envelope status information from the one or more camera modules;
receive environmental information including current wind conditions at the launch facility from the one or more environmental sensors;
analyze the balloon envelope status information and the environmental information based on one or more launch models;
select, based on the analyzing, a launch time; and
cause the lighter-than-air platform to be launched at the launch time.

18. The launch system of claim 17, wherein the one or more camera modules are configured to capture imagery of a status of the launch rig during fill of the balloon envelope with lift gas.

19. The launch system of claim 17, wherein the one or more processors are further configured to control inflation of the balloon envelope in response to at least one of the analyzed balloon envelope status information or the environmental information.

20. The launch system of claim 17, wherein:
the one or more camera modules are configured to capture post-launch imagery of the lighter-than-air platform; and
the one or more processors are configured to update the one or more launch models based on the post-launch imagery.
